(19) United States
(12) Patent Application Publication
(10) Pub. No.: US 2007/0014930 A1
(43) Pub. Date: Jan. 18, 2007

(54) Method for forming anticorrosion layer

(76) Inventors: Huann-Wu Chiang, Kaohsiung City (TW); Chi-Shiung Hsu, Sindian City (TW); A-Tzu Chen, Jhonghe City (TW); Jaw-Min Chou, Tainan City (TW); Ming-Hui Yu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/485,994

(22) Filed: Jul. 14, 2006

(30) Foreign Application Priority Data
Jul. 15, 2005 (TW) 94124150

(51) Int. Cl. B05D 3/02; B05D 7/00; B05D 1/18

(52) U.S. Cl. 427/372.2; 427/421.1; 427/430.1

(57) ABSTRACT

The present invention provides a method for forming an anticorrosion layer, and more particularly, a method for forming an anticorrosion layer against high corrosivity of lead-free solders. The method for forming an anticorrosion layer comprises the steps of firstly providing a article having a metal surface; then providing a ceramic material having oxide, nitride, carbide, boride or a mixture of oxide, nitride, carbide and boride; then adhering the ceramic material to the metal surface of the article; and finally bonding the ceramic material to the metal surface of the article. Said article is a tin slot, peripherals of the tin slot or a temperature probe.

### BACKGROUND OF THE INVENTION

1. Field of the Invention

The present invention relates to a method for forming an anticorrosion layer, and more particularly, to a method for forming an anticorrosion layer which is developed against high corrosivity of lead-free solders to be applied to a tin slot, peripherals of the tin slot or a temperature probe.

2. Description of Related Art

Due to good mechanical property, soldering compatibility, wetting property and joining property, traditional tin-lead alloy solders have long been used widely, for example, as common joining materials for electronic packaging, which have low cost and can be made into solders of high, middle and low melting points by adjusting constituents thereof.

However, the lead component in solders is greatly harmful to human health, which is prohibited of use by all the countries in the world. Therefore, each related research institute is actively devoted to the development of lead-free solders. In view of the development results in the past few years, most of them are centered on new lead-free solders. Although the lead-free solders could meet lead-free requirement, they have caused higher corrotivity which makes a tin slot including common soldering slots, wave soldering slots and the like, or peripherals of the tin slot corroded by the lead-free solders. Such a problem has not been resolved until now.

For example, FIG. 1 shows a tin slot configuration which is disclosed in Taiwan Patent TW421094. The tin slot configuration includes a tin slot 1 and a motor 12 arranged at outer side of the tin slot 1, which drives a pivot 14 set at the opening edge of the tin slot 1 to rotate by a belt 13. A splitter slot 15 is provided at the inner side of the tin slot 1. One end of the pivot 14 extends into the tin slot 1. A channel 16 is arranged on the splitter slot 15. Wherein, the motor 12 arranged on a fixed seat (not shown) drives the pivot 14 to rotate by the belt 13, and the solders flow out of the splitter slot 15, overflow via the channel 16, and then contact with the circuit board constructed on the substrate (not shown) to achieve soldering.

If lead-free solders are used in said patent, not only the tin slot 1 is tended to be corroded by the lead-free solders, but also any peripheral of the tin slot contacting with the lead-free solders, for example agitation blades used in the wave soldering slot, the splitter slot 15 and the channel 16, will be corroded by the lead-free solders.

The research about the Sn—Cu, Sn—Bi, Sn—Ag—Cu lead-free alloys wave soldering shows that the main disadvantages of these lead-free solders lie in low soldering yield, fillet lifting, poor wetting property of the solders on printed circuit board (PCB) elements, increase of the amount of the soldering slag, variation and pollution of the alloy components during continual manufacturing process and leaching of the tin slot metal. Moreover, 300 Series stainless steel is used by most of the devices lack of adequate preheating ability as the material of the tin slot. Some manufacturers specially treat the stainless steel, while some use ferrosteel as the material. Under general use conditions, the life of the tin slot using lead tin solders is as long as 5-6 years. The lead-free solders have a higher content of tin, and the operational temperature is about 50° C. higher than that of conventional tin lead alloys. Therefore, the melting tin is tended to influence and dissolve the chromic oxide protection layer of the stainless steel surface, so that the tin slot metal is gradually dissolved into the melting solders, causing the tin slot corroded, perforated or broken. This is one of the reasons why the lead-free solders have higher corrosivity.

Therefore, regarding to the lead-free solders having higher corrosivity, how to make the tin slot (common soldering slot and wave soldering slot), the peripherals of the tin slot or a temperature probe have the function of anticorrosion is a big problem for the inventors to overcome and resolve.

### SUMMARY OF THE INVENTION

According to the method for forming an anticorrosion layer of the invention, an anticorrosion layer is formed against higher corrosivity of the lead-free solders by adhering the ceramic material to the whole or partial metal surface of an article, thereby the use life of the article will not be shortened.

In order the address the above-mentioned problems, an object of the present invention is to provide a method for forming an anticorrosion layer against the higher corrosivity of the lead-free solders. Said method comprises: providing an article which has a metal surface; providing a ceramic material having oxide, nitride, carbide, boride or a mixture of oxide, nitride, carbide and boride; adhering the ceramic material to the metal surface of the article; and bonding the ceramic material to the metal surface of the article.

Another object of the present invention is to provide a method for forming an anticorrosion layer for a tin slot having heating tubes, so as to resist the higher corrosivity of the lead-free solders. Said method comprises: providing a tin slot having a plurality of inner metal walls, wherein a plurality of hollow outer metal tubes are bridged between a pair of opposite inner walls and a heating tube is interposed in the hollow space of each outer tube; providing a ceramic material having oxide, nitride, carbide, boride or a mixture of oxide, nitride, carbide and boride; adhering the ceramic material to the inner walls of the tin slot and the outer walls of the outer tubes; and bonding the ceramic material to the inner walls of the tin slot and the outer walls of the outer tubes.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view of the outline of the conventional tin slot;

FIG. 2 is the first flow chart of the method for forming an anticorrosion layer according to the invention;

FIG. 3 is the second flow chart of the method for forming an anticorrosion layer according to the invention; and

FIG. 4 is a sectional schematic view to apply the method for forming an anticorrosion layer of the invention to a tin slot.

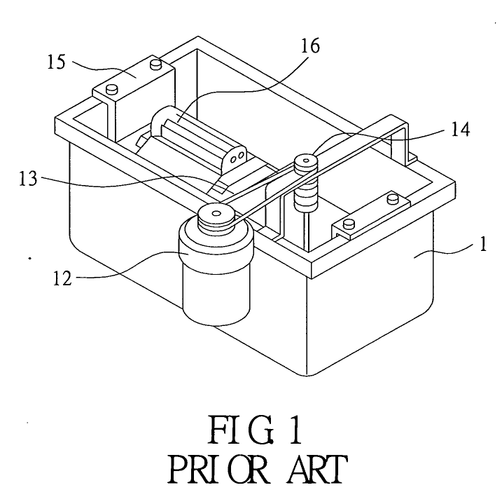

### DETAILED DESCRIPTION OF PREFERRED EMBODIMENTS

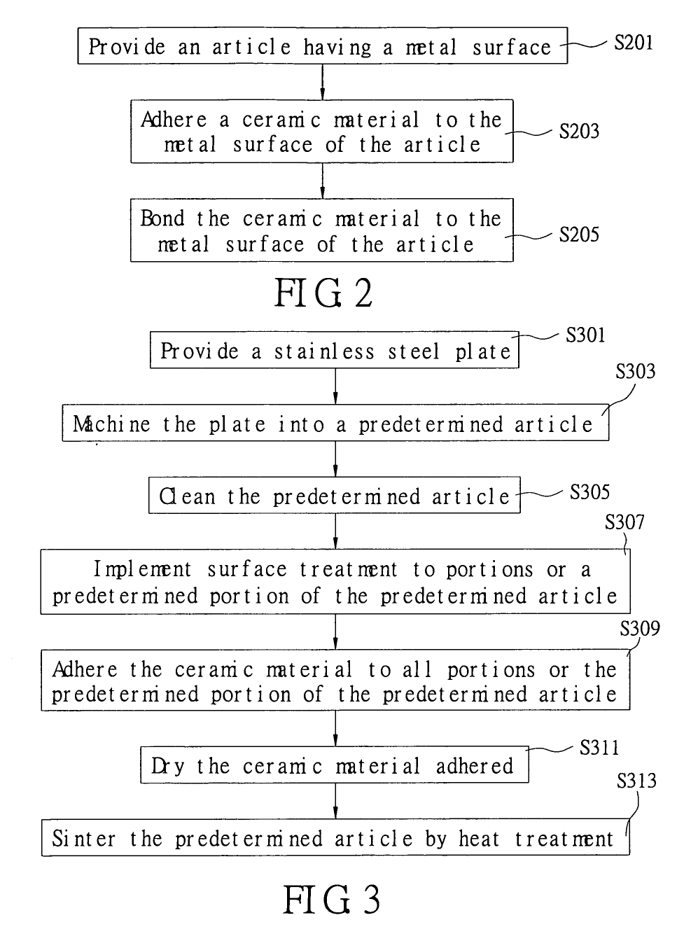

With reference to FIGS. 2-4, the present invention provides a method for forming an anticorrosion layer against high corrosivity of lead-free solders. Herein, there embodiments are described. In the first embodiment, the anticorrosion layer is formed for an existing article. In the second embodiment, a predetermined article is manufactured and processed for forming the anticorrosion layer. In the third embodiment, then anticorrosion layer is formed for a tin slot having a plurality of heating tubes.

Referring to FIG. 2, the flow char of forming the anticorrosion layer on an existing article is described. The method for forming the anticorrosion layer comprises: providing an article which has a metal surface (S201); adhering a ceramic material to the metal surface of the article (S203), wherein the ceramic material has oxide, nitride, carbide, boride, or a mixture of oxide, nitride, carbide and boride; and bonding the ceramic material to the metal surface of the article (S205). Whereby the anticorrosion layer made of the ceramic material is formed on the metal surface of the article.

The ceramic material is bonded to the metal surface by firstly drying the ceramic material adhered already and then sintering the article and the ceramic material thereon through heat treatment, so that the ceramic material is firmly adhered to the metal surface without peeling. The ceramic material is adhered to the whole or partial metal surface of the article. The partial metal surface of the article means any portion the article contacting with the lead-free solders.

Furthermore, the article can be a tin slot (common soldering slot or wave soldering slot), peripherals of the tin slot or a temperature probe. The peripherals are embodied as one or more splitter slots, channels, jet nozzles, agitation blades and the like, to which the method of the invention could be adapted to form the anticorrosion layer.

Moreover, the ceramic material could be liquid or paste, so that it could be adhered to the metal surface or partial metal surface of the article by spraying, perfusing, coating or smearing as well as by plasma spraying, heat spraying or slurry coating. The ceramic material could also be shaped as hard lumps or hard pieces, so that it could be adhered to zthe metal surface or partial metal surface of the article by pasting or sticking. Herein, heat treatment is not needed by the anticorrosion layer made by plasma spraying or heat spraying, while it is needed by the ceramic slurry coating layer made by manual coating or machine coating to form the anticorrosion layer by sintering the ceramic slurry coating layer on the steel surface. The article coated prior to sintering may be dried in a drying furnace by heated air at 60-120° C. or radiation at 150-250° C. for 5-25 minutes. Generally, the sintering temperature of the ceramic slurry at the bottom is between 600° C. and 1000° C., and that of the ceramic slurry at the surface is between 700° C. and 2000° C. The ceramic (powder) material could even be heated above the sintering temperature thereof.

Referring to FIG. 3, the flow chart of manufacturing and processing a predetermined article for forming the anticorrosion layer is described. The method for forming the anticorrosion layer comprises: providing a stainless steel plate (S301), which could be an austenitic stainless steel plate, such as SUS301, SUS304 and SUS316; machining the stainless steel plate into a predetermined article by a punch, a welding machine and the like (S303), which could be a tin slot, the peripherals of the tin slot or a temperature probe; cleaning the predetermined article manufactured, for example, by a cleaning bench (S305), so as to facilitate the adherence of the anticorrosion layer; implementing surface treatment to all portions or a predetermined portion of the predetermined article by a surface treatment device (S307), wherein said predetermined portion of the predetermined article means any portion the predetermined article contacting with the lead-free solders, the method of surface treatment means providing a layer of ceramic material, and the layer of ceramic materials includes oxide, nitride, carbide, boride, or a mixture of oxide, nitride, carbide and boride; adhering the ceramic material to all portions or the predetermined portion of the predetermined article by using ceramic adhering tools or ceramic adhering equipment (S309); dying the ceramic material adhered by using a drying furnace (S311); sintering the predetermined article adhered with the ceramic material by heat treatment using a heating furnace (S313), so that the ceramic material is bonded to the predetermined surface, thereby the anticorrosion layer made of the ceramic material is formed on the surface of the predetermined article.

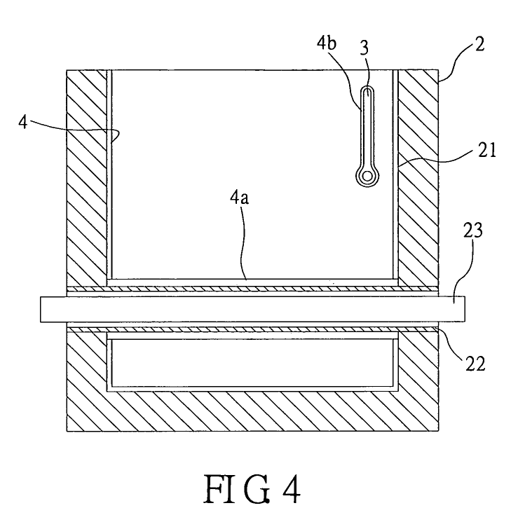

Referring to FIG. 4, the anticorrosion layers 4, 4a are formed in a tin slot 2 having a plurality of heating tubes 23. The method for forming the anticorrosion layer comprises: providing a tin slot 2 which has a plurality of inner metal walls 21, wherein a plurality of hollow outer metal tubes 22 are bridged between a pair of opposite inner walls 21, and a heating tube 23 is interposed in the hollow space of each outer tube 22; providing a ceramic material (not shown) having oxide, nitride, carbide, boride or a mixture of oxide, nitride, carbide and boride; adhering the ceramic material to the inner walls 21 of the tin slot 2 and the outer walls of the outer tubes 22; and forming the anticorrosion layers 4 and 4a as shown by bonding the ceramic material to the inner walls 21 of the tin slot 2 and the outer walls of the outer tubes 22 respectively.

The ceramic material is bonded to the inner walls 21 of the tin slot 2 and the outer walls of the outer tubes 22 by firstly drying the ceramic material adhered already and then sintering the tin slot 2 having a plurality of outer tubes 22 as well as the ceramic material on the tin slot 2 and the outer tubes 22 through heat treatment, so that the ceramic material is firmly adhered to the inner walls 21 of the tin slot 2 and the outer walls of the outer tubes 22 without peeling. The ceramic material is adhered to the whole or partial inner metal walls 21 of the tin slot 2. The partial inner metal walls 21 of the tin slot 2 mean any portion the inner walls 21 contacting with the lead-free solders.

Moreover, a further temperature probe 3 is set within the tin slot 2. Said ceramic material is adhered to the temperature probe 3. An anticorrosion layer 4b as shown is formed by bonding the ceramic material to the temperature probe 3. Conventionally, the tin slot 2 not only has the temperature tube 3 contacted with the lead-free solders, but also has a plurality of peripherals of the tin slot 2 contacted with the lead-free solders, such as splitter slots, channels, jet nozzles, agitation blades for wave soldering slots, and the like, to which the method of the invention could be adapted to form the anticorrosion layer.

The ceramic material could be liquid or paste, so that it could be adhered to the (partial) inner walls 21 of the tin slot 2 and the outer walls of the outer tubes 22 by spraying, perfusing, coating or smearing as well as by plasma spraying, heat spraying or slurry coating. The ceramic material could also be shaped as hard lumps or hard pieces, so that it could be adhered to the inner walls 21 of the tin slot 2 and the outer walls of the outer tubes 22 by pasting or sticking. Herein, heat treatment is not needed by the anticorrosion layer made by plasma spraying or heat spraying, while it is needed by the ceramic slurry coating layer made by manual coating or machine coating to form the anticorrosion layer by sintering the ceramic slurry coating layer on the steel surface. The tin slot coated prior to sintering may be dried in a drying furnace by heated air at 60-120° C. or radiation at 150-250° C. for 5-25 minutes. Generally, the sintering temperature of the ceramic slurry at the bottom is between 600° C. and 1000° C., and that of the ceramic slurry at the surface is between 700° C. and 2000° C. The ceramic (powder) material could even be heated above the sintering temperature thereof.

According to the aforementioned embodiments, the higher corrosivity of the lead-free solders could be overcome by the anticorrosion layer formed, and the use life thereof will not be shortened. The major components of the ceramic material in the embodiments include SiO₂, Al₂O₃, B₂O₂, Na₂O, K₂O, Li₂O, CaO, and a mixture of CoO, MgO, Fe₂O₃, TiO₂, SiC, AlN and NiO. The lead-free solders adaptable to the anticorrosion layer formed by the method of the invention are Sn-based lead-free solders, such as Sn—Ag—Cu, Sn—Cu, Sn—Ag and the like.

The lead-free solders of higher corrosivity are necessary in view of environmental protection factors. The anticorrosion layer is only formed on the articles contacting with the lead-free solders by the method of the invention, such as the tin slot, the peripherals of the tin slot or a temperature probe, so as to resist the higher corrosivity of the lead-free solders. Therefore, the lead-free solders hardly erode or corrode each article, and the use life of the article will not be shortened in turn.

With regard to the stainless steel tended to be corroded by the lead-free solders, after the anticorrosion layer is formed on the whole or partial stainless steel surface by the method of the invention, the stainless steel will not be corroded even in contact with the lead-free solders for 1000 hours under 500° C. Furthermore, since the operational temperature of common wave soldering is only about 260° C., no reaction will take place, thereby longer use life is achieved.

To sum up, the method for forming an anticorrosion layer provided by the invention surely could address the problems that the lead-free solders tend to corrode the articles contacting with them. The method could be applied to any article contacting with the lead-free solders due to its industry value and improvement in efficacy.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for forming an anticorrosion layer against higher corrosivity of lead-free solders, comprising:
providing an article having a metal surface;
providing a ceramic material having oxide, nitride, carbide, boride, or a mixture of oxide, nitride, carbide and boride;
adhering the ceramic material to the metal surface of the article; and
bonding the ceramic material to the metal surface of the article.

2. The method as claimed in claim 1, wherein the ceramic material is liquid or paste, and the ceramic material is adhered to the metal surface of the article by spraying, per fusing, coating, smearing or immersing.

3. The method as claimed in claim 1, wherein the ceramic material is shaped as hard lumps or hard pieces, and the ceramic material is adhered to the metal surface of the article by pasting or sticking.

4. The method as claimed in claim 1, wherein the major components of the ceramic material include SiO₂, Al₂O₃, B₂O₂, Na₂O, K₂O, Li₂O, CaO, and a mixture of CoO, MgO, Fe₂O₃, TiO₂, SiC, AlN and NiO.

5. The method as claimed in claim 1, wherein the lead-free solders are Sn-based lead-free solders, such as Sn—Ag—Cu, Sn—Cu or Sn—Ag.

6. The method as claimed in claim 1, wherein the ceramic material is adhered to the partial metal surface of the article that contacts with the lead-free solders.

7. The method as claimed in claim 1, wherein the article is a temperature probe, a tin slot or peripherals of the tin slot.

8. The method as claimed in claim 7, wherein the peripherals of the tin slot are one or more splitter slots, channels, jet nozzles or agitation blades.

9. A method for forming an anticorrosion layer against higher corrosivity of lead-free solders, comprising:
providing an tin slot having a plurality of inner metal walls, wherein a plurality of hollow outer metal tubes are bridged between a pair of opposite inner walls and a heating tube is interposed in the hollow space of each outer tube;
providing a ceramic material having oxide, nitride, carbide, boride, or a mixture of oxide, nitride, carbide and boride;
adhering the ceramic material to the inner walls of the tin slot and the outer walls of the outer tubes; and
bonding the ceramic material to the inner walls of the tin slot and the outer walls of the outer tubes.

10. The method as claimed in claim 9, wherein the ceramic material is liquid or paste, and the ceramic material is adhered to the inner walls of the tin slot and the outer walls of the outer tubes by spraying, perfusing, coating or smearing.

11. The method as claimed in claim 9, wherein the ceramic material is shaped as hard lumps or hard pieces, and the ceramic material is adhered to the inner walls of the tin slot and the outer walls of the outer tubes by pasting or sticking.

12. The method as claimed in claim 9, wherein the major components of the ceramic material include SiO₂, Al₂O₃, B₂O₂, Na₂O, K₂O, Li₂O, CaO, and a mixture of CoO, MgO, Fe₂O₃, TiO₂, SiC, AlN and NiO.

13. The method as claimed in claim 9, wherein the lead-free solders are Sn-based lead-free solders, such as Sn—Ag—Cu, Sn—Cu or Sn—Ag.

14. The method as claimed in claim 9, wherein the ceramic material is adhered to the partial inner metal walls of the tin slot that contacts with the lead-free solders.

15. The method as claimed in claim 9, wherein a temperature probe is set within the tin slot, said ceramic material is further adhered to the temperature probe, then said ceramic material is bonded to the temperature probe.

16. The method as claimed in claim 9, wherein a plurality of peripherals is further set within the tin slot.

17. The method as claimed in claim 16, wherein the peripherals of the tin slot are one or more splitter slots, channels, jet nozzles or agitation blades.
